(19) United States
(12) Patent Application Publication
(10) Pub. No.: US 2021/0143442 A1
(43) Pub. Date: May 13, 2021

(54) CATALYST FOR FUEL CELL AND MANUFACTURING METHOD THEREOF

(71) Applicant: HYUNDAI MOBIS CO., LTD., Seoul (KR)

(72) Inventors: Eunyoung YOU, Yongin-si (KR); Dae Jong YOU, Yongin-si (KR)

(21) Appl. No.: 16/865,781

(22) Filed: May 4, 2020

(30) Foreign Application Priority Data
Nov. 7, 2019 (KR) 10-2019-0141557

(51) Int. Cl. H01M 4/92; H01M 4/88

(52) U.S. Cl. CPC H01M 4/921; H01M 4/8882; H01M 4/926

(57) ABSTRACT

A fuel cell catalyst and a method for manufacturing the same are disclosed. The fuel cell catalyst includes: a support including titanium suboxide and carbon; and an active material supported on the support and including iridium (Ir), ruthenium (Ru), and yttrium (Y). The active material is represented by the following Formula 1: [Formula 1] IrRuₐY_{b}, wherein a is between 1 and 5 (1≤a≤5), and b is between 0.1 and 2 (0.1≤b≤2).

### CROSS-REFERENCE TO RELATED APPLICATION

The present application claims priority under 35 U.S.C. § 119(a) to Korean Patent Application No. 10-2019-0141557, filed on Nov. 07, 2019 in the Korean Intellectual Property Office, which is incorporated herein by reference in its entirety.

### BACKGROUND

### 1. Technical Field

Embodiments of the present disclosure relate to a fuel cell catalyst and a method for manufacturing the same, and more particularly, to a fuel cell electrode catalyst having excellent durability and a method for manufacturing the same.

### 2. Related Art

A fuel cell is a device that generates electricity by converting chemical energy into electrical energy by oxidation of the fuel hydrogen. The fuel cell may use hydrogen produced using renewable energy, produces water as a reaction product, and is attracting attention as an environmentally friendly energy source since it produces no air pollutants or greenhouse gases. The fuel cell is divided, according to the kinds of electrolyte and fuel used, into a polymer electrolyte membrane fuel cell (PEMFC), a direct methanol fuel cell (DMFC), a phosphoric acid fuel cell (PAFC), a molten carbonate fuel cell (MCFC) and a solid oxide fuel cell (SOFC).

Among them, the polymer electrolyte membrane fuel cell (PEMFC) has a relatively low operating temperature, a high energy density, fast start-up characteristics and excellent response characteristics, and thus studies on technology for using it as an energy source for automobiles, various electronic devices, transportation and power generation have been actively conducted.

The fuel cell includes a structure in which a membrane electrode assembly (MEA), which includes a membrane, an anode and a cathode, a gas diffusion layer (GDL) and a separator, are stacked. The anode and the cathode each include a catalyst layer composed of a metal catalyst, a catalyst including a support that supports the metal catalyst, and an ionomer that is a proton transfer-mediating polymer.

In a fuel cell, hydrogen is supplied to the anode, and oxygen is supplied to the cathode. The catalyst of the anode oxidizes the hydrogen to form protons, and the protons pass through the electrolyte membrane, which is a proton conductive membrane, and react with oxygen by the catalyst of the cathode to produce electricity and water.

FIG. 1 schematically shows a hydrogen oxidation reaction that occurs in an anode catalyst layer of a conventional fuel cell. Referring to FIG. 1, under normal operating conditions, hydrogen supplied to a fuel cell anode (hydrogen electrode) is separated into protons and electrons (H₂→2H⁺+2e⁻). Electricity is generated by the movement of the separated electrons, and the protons, electrons and the oxygen come into contact with each other to generate heat while producing water (H₂O). A catalyst is used to increase the efficiency of the reaction. As the conventional fuel cell anode catalyst, platinum (Pt) having excellent hydrogen oxidation and oxygen reduction reaction characteristics is used, and as a support for supporting the catalyst, a carbon (C) support having a large specific surface area (100 m²/g or more) and excellent electrical conductivity (less than 1 S/cm) is used.

Meanwhile, if the supply of fuel (H₂) to the fuel cell anode is insufficient, as shown in FIG. 1, the hydrogen oxidation reaction in the anode will not occur normally, and a phenomenon will occur in which the required electrons tend to be supplied from the oxidation of the anode catalyst support carbon. For this reason, problems arise in that the catalyst support carbon is oxidized (CO₂+2H⁺+2e⁻) and the dissolution and aggregation of platinum occurs.

In addition, considering the thermodynamic reduction potential (0.207 V vs. SHE) of the carbon, within the driving range of the fuel cell, there are problems in that ultimately the carbon is corroded and the corrosion of the carbon support acts as a direct cause of shortening the life of the fuel cell catalyst.

The background art related to the present disclosure is disclosed in Korean Patent No. 10-1467061 (published on Dec. 2, 2014; entitled “Method for Manufacturing Cubic Pt/C Catalyst, Cubic Pt/C Catalyst Manufactured Thereby and Fuel Cell Using the Same”).

### SUMMARY

An object of the present disclosure is to provide a fuel cell catalyst having excellent durability, corrosion resistance and stability.

Another object of the present disclosure is to provide a fuel cell catalyst having excellent oxygen evolution reaction activity and hydrogen oxidation activity.

Still another object of the present disclosure is to provide a fuel cell catalyst which has an excellent activity of promoting an oxygen evolution reaction and a water decomposition reaction, and thus has an excellent effect of preventing catalyst from deteriorating, by preventing the corrosion reaction of a carbon support from occurring when a fuel starvation occurs.

Yet another object of the present disclosure is to provide a fuel cell catalyst exhibiting lightweight and environmentally friendly characteristics.

Still yet another object of the present disclosure is to provide a fuel cell catalyst having excellent productivity and economic efficiency.

A further object of the present disclosure is to provide a method for manufacturing the fuel cell catalyst.

Another further object of the present disclosure is to provide an electrode including a catalyst manufactured by the method for manufacturing the fuel cell catalyst, or an electrode including the fuel cell catalyst.

Still another further object of the present disclosure is to provide a fuel cell including a catalyst manufactured by the method for manufacturing the fuel cell catalyst, or a fuel cell including the fuel cell catalyst.

One aspect of the present disclosure is directed to a fuel cell catalyst. In one embodiment, the fuel cell catalyst includes: a support including titanium suboxide and carbon; and an active material supported on the support and including iridium (Ir), ruthenium (Ru) and yttrium (Y).

In one embodiment, the active material may be represented by the following Formula 1:

IrRuₐY_{b} [Formula 1]

wherein a is between 1 and 5 (1≤a≤5), and b is between 0.1 and 2 (0.1≤b≤2).

In one embodiment, the support may include 100 parts by weight of titanium suboxide and about 1 to 20 parts by weight of carbon.

In one embodiment, the active material and the support may be included at a weight ratio of about 1:0.5 to 1:20.

In one embodiment, the carbon may include one or more of carbon black, carbon nanotubes (CNTs), graphite, graphene, activated carbon, mesoporous carbon, carbon fibers, and carbon nanowires.

Another aspect of the present disclosure is directed to a method for manufacturing the fuel cell catalyst. In one embodiment, the method for manufacturing the fuel cell catalyst includes: preparing a first mixture including titanium suboxide, carbon and a solvent; preparing a second mixture by adding an iridium (Ir) precursor, a ruthenium (Ru) precursor, and a yttrium (Y) precursor to the first mixture; and preparing an intermediate using the second mixture.

In one embodiment, the first mixture may be prepared by adding the titanium suboxide and the carbon to the solvent, followed by ultrasonic dispersion.

In one embodiment, the solvent may include one or more of water, isopropyl alcohol, methanol, ethanol, ethylene glycol, and propylene glycol.

In one embodiment, the solvent may include about 10 to 50 vol % of water and about 50 to 90 vol % of ethylene glycol.

In one embodiment, the iridium (Ir) precursor, the ruthenium (Ru) precursor and the yttrium (Y) precursor may be added at a molar ratio of about 1:1 to 5:0.1 to 2.

In one embodiment, the second mixture may have a pH of about 1 to 6.

In one embodiment, the intermediate may be prepared by irradiating the second mixture with an electron beam.

In one embodiment, the irradiating with the electron beam may be performed by irradiating the second mixture with an electron beam at about 100 to 500 keV.

In one embodiment, the method may further include heat-treating the prepared intermediate at a temperature of about 200 to 400° C.

In other embodiments, the intermediate may be prepared by heat-treating the second mixture at a temperature of about 150 to 280° C.

Still another aspect of the present disclosure is directed to an electrode including a catalyst manufactured by the method for manufacturing the fuel cell catalyst, or an electrode including the fuel cell catalyst.

Yet another aspect of the present disclosure is directed to a fuel cell including the fuel cell catalyst.

The fuel cell catalyst according to the present disclosure may have excellent durability and stability, excellent catalytic performances such as oxygen evolution reactivity and hydrogen oxidation activity, lightweight and environmentally friendly characteristics, and excellent productivity and economic efficiency.

In addition, the fuel cell catalyst according to the present disclosure may have an excellent activity of promoting an oxygen evolution reaction and a water decomposition reaction. Thus, when a fuel starvation occurs, the fuel cell catalyst may exhibit an excellent effect of promoting the water decomposition reaction, thereby preventing catalyst from deteriorating by a carbon corrosion reaction caused by a phenomenon in which electrons tend to be supplied from a carbon support's oxidation.

### BRIEF DESCRIPTION OF THE DRAWINGS

FIG. 1 schematically shows oxidation reactions that occur in an anode catalyst layer under normal operating fuel cell and under insufficient fuel supplying fuel cell.

FIG. 2 shows a method for manufacturing a fuel cell catalyst according to one embodiment of the present disclosure.

FIG. 3 is a graph showing the comparison of the oxygen evolution reaction activities of Examples 1 to 4 and Comparative Example 2.

### DETAILED DESCRIPTION

In the following description, the detailed description of related publicly-known technology or configuration will be omitted when it may unnecessarily obscure the subject matter of the present disclosure.

In addition, the terms used in the following description are terms defined taking into consideration the functions obtained in accordance with embodiments of the present disclosure, and may be changed in accordance with the option of a user or operator or a usual practice. Accordingly, the definition of the terms should be made based on the contents throughout the present specification.

Fuel Cell Catalyst

One aspect of the present disclosure is directed to a fuel cell catalyst. In one embodiment, the fuel cell catalyst includes: a support including titanium suboxide (Ti₄O₇) and carbon; and an active material supported on the support and including iridium (Ir), ruthenium (Ru) and yttrium (Y).

Support

The support includes titanium suboxide and carbon. When titanium suboxide (Ti₄O₇) and carbon are included as the components of the support, they may improve the durability of the support due to their excellent electrical conductivity and corrosion resistance, thereby increasing the life of the catalyst.

As the titanium suboxide, one prepared by a conventional method may be used. In one embodiment, the titanium suboxide (Ti₄O₇) may have a specific surface area of about 5 to 80 m²/g. Under this condition, the catalyst may have excellent durability, structural stability and catalytic activity.

In one embodiment, the average size (d50) of the titanium suboxide may be about 10 nm to 10 μm. The size may be the maximum length or diameter of the titanium suboxide. Under this condition, the electrochemical activity, miscibility, and dispersibility of the catalyst are excellent.

In one embodiment, the specific surface area of the carbon may be about 30 to 1500 m²/g. Under this condition, the catalyst may have excellent durability, structural stability and catalytic activity.

In one embodiment, the average size (d50) of the carbon may be about 10 nm to 1 μm. The size may be the maximum length or diameter of the carbon. Under this condition, dispersibility, catalytic activity and electrochemical activity may be excellent.

In one embodiment, the carbon may include one or more of carbon black, carbon nanotubes (CNTs), graphite, graphene, activated carbon, mesoporous carbon, carbon fibers, and carbon nanowires.

In one embodiment, the support may include 100 parts by weight of titanium suboxide and about 1 to 20 parts by weight of carbon. Under these content conditions, the catalyst may have excellent electrical conductivity while having excellent corrosion resistance and durability. For example, the support may include 100 parts by weight of titanium suboxide and about 3 to 13 parts by weight of carbon. For example, the carbon may be included in an amount of about 1, 2, 3, 4, 5, 6, 7, 8, 9, 10, 11, 12, 13, 14, 15, 16, 17, 18, 19 or 20 parts by weight based on 100 parts by weight of the titanium suboxide.

Active Material

In one embodiment, the active material may be represented by the following Formula 1:

IrRuₐY_{b} [Formula 1]

wherein a is between 1 and 5 (1≤a≤5), and b is between 0.1 and 2 (0.1≤b≤2).

When the iridium (Ir), ruthenium (Ru) and yttrium (Y) satisfy the conditions of Formula 1 above, they may be stably supported on the support, and thus the catalyst may have excellent stability and durability, and the effect of improving the hydrogen oxidation reaction activity and oxygen evolution reaction (OER) activity of the catalyst may be excellent. For example, in Formula 1 above, a may be between 3 and 4, and b may be between 0.3 and 0.6.

In one embodiment, the active material and the support may be included at a weight ratio of about 1:0.5 to 1:20. When they are included at a weight ratio within the above range, the active material may be stably supported on a support, and thus the durability and stability of the catalyst may be excellent. For example, they may be included at a weight ratio of about 1:2 to 1:5.

Method for Manufacturing Fuel Cell Catalyst

Another aspect of the present disclosure is directed to a method for manufacturing the fuel cell catalyst. FIG. 2 shows a method for manufacturing a fuel cell catalyst according to one embodiment of the present disclosure. Referring to FIG. 2, the method for manufacturing the fuel cell catalyst includes the steps of: (S10) preparing a first mixture; (S20) preparing a second mixture; and (S30) preparing an intermediate. More specifically, the method for manufacturing the fuel cell catalyst includes the steps of: (S10) preparing a first mixture including titanium suboxide, carbon and a solvent; (S20) preparing a second mixture by adding an iridium (Ir) precursor, a ruthenium (Ru) precursor, and a yttrium (Y) precursor to the first mixture; and (S30) preparing an intermediate using the second mixture.

Hereinafter, each step of the method for manufacturing the fuel cell catalyst will be described in detail.

(S10) Step of Preparing First Mixture

This step is a step of preparing a first mixture including titanium suboxide, carbon and a solvent. The titanium suboxide and carbon used in this step may be the same as described above, and thus the detailed description thereof is omitted.

In one embodiment, the first mixture may be prepared by adding titanium suboxide and carbon to the solvent, followed by ultrasonic dispersion. When the ultrasonic dispersion is performed, the titanium suboxide and the carbon may be dispersed homogeneously, and the structural stability of the support may be excellent. For example, the ultrasonic dispersion may be performed for 1 to 60 minutes.

In one embodiment, the solvent may include a hydroxyl group (-OH)-containing solvent. For example, the solvent may include one or more of water, an alcohol-based solvent, and a glycol-based solvent. For example, the solvent may include one or more of water, isopropyl alcohol, methanol, ethanol, ethylene glycol, and propylene glycol. When the solvent satisfying this condition is used, the efficiency of dispersion of the titanium suboxide, the carbon and the precursors to be described later may be excellent, and the efficiency of reduction upon electron beam irradiation may be excellent. In addition, the use of the water-based solvent may have excellent environmental friendliness.

In one embodiment, the solvent may include about 10 to 50 vol % of water and about 50 to 90 vol % of ethylene glycol. When the solvent satisfying this condition is used, the efficiency of dispersion of the titanium suboxide, the carbon and the precursors to be described later may be excellent, and the efficiency of reduction upon electron beam irradiation may be excellent. In addition, the use of the water-based solvent may have excellent environmental friendliness. For example, the solvent may include about 30 to 50 vol % of water and about 50 to 70 vol % of ethylene glycol.

In one embodiment, the first mixture may include 100 parts by weight of titanium suboxide, about 1 to 20 parts by weight of carbon, and about 100 to 1500 parts by weight of the solvent. Under these content conditions, the dispersibility of the first mixture, the activity of the catalyst, and the durability of the support may be excellent.

(S20) Step of Preparing Second Mixture

This step is a step of preparing a second mixture by adding an iridium (Ir) precursor, a ruthenium (Ru) precursor, and a yttrium (Y) precursor to the first mixture.

As for the iridium precursor, a conventional one may be used. For example, the iridium precursor may include one or more of iridium nitrate, iridium chloride, iridium sulfate, iridium acetate, iridium acetylacetonate, iridium cyanate, and iridium isopropyloxide.

As for the ruthenium precursor, a conventional one may be used. For example, the ruthenium precursor may include one or more of ruthenium chloride, ruthenium acetylacetonate, and ruthenium nitrosylacetate.

As for the yttrium precursor, a conventional one may be used. For example, the yttrium precursor may include one or more of yttrium nitrate, yttrium nitride, yttrium acetate, yttrium acetylacetonate, yttrium chloride, and yttrium fluoride.

In one embodiment, the iridium (Ir) precursor, the ruthenium (Ru) precursor, and the yttrium (Y) precursor may be added at a molar ratio of about 1:1 to 5:0.1 to 2. When these precursors are added at this molar ratio, they may have excellent dispersibility and be stably supported on the support, and thus the stability and durability of the catalyst may be excellent, and the effect of improving the hydrogen oxidation reaction activity and oxygen evolution reaction (OER) activity of the catalyst may be excellent. For example, these precursors may be added at a molar ratio of about 1:3 to 4:0.3 to 0.6.

In one embodiment, the second mixture may include the sum of the iridium precursor, the ruthenium precursor and the yttrium precursor and the sum of the titanium suboxide and the carbon at a weight ratio of about 1:0.5 to 1:20. When the second mixture includes the sums at a weight ratio within the above range, the active material may be stably supported on the support, and thus the durability and stability of the catalyst may be excellent. For example, the sums may be included at a weight ratio of about 1:2 to 1:5.

In one embodiment, the second mixture may have a pH of about 1 to 6. Under this pH condition, the dispersibility of the second mixture may be excellent, and the efficiency of reduction of the second mixture upon electron beam irradiation may be excellent.

(S30) Step of Preparing Intermediate

This step is a step of preparing an intermediate using the second mixture.

In one embodiment, the intermediate may be prepared by irradiating the second mixture with an electron beam. When the intermediate is prepared by applying electron beam irradiation as described above, the process of manufacturing the fuel cell catalyst may be simplified, and thus productivity and economic efficiency may be excellent. In addition, since a chemical reducing agent is not used, environmental friendliness may be excellent.

In one embodiment, the electron beam irradiation may be performed by irradiating the second mixture with an electron beam at about 100 to 500 keV. Under this condition, the second mixture may be sufficiently reduced to form the intermediate. For example, the second mixture may be irradiated with an electron beam at about 200 to 400 keV for about 1 to 60 minutes.

In one embodiment, the intermediate may be prepared by irradiating the second mixture with an electron beam, filtering the irradiated second mixture, and then washing the second mixture with distilled water.

In other embodiments of the present disclosure, the method may further include a step of heat-treating the prepared intermediate. In one embodiment, the heat treatment may be performed by heating the intermediate, prepared by irradiating the second mixture with the electron beam, at a temperature of about 200 to 400° C. When the heat treatment is performed under this condition, the activity and durability of the catalyst may be further improved.

In other embodiments, the intermediate may be prepared by heat-treating the second mixture at a temperature of about 150 to 280° C. When the heat treatment is performed at a temperature within this range, the activity and durability of the catalyst may be excellent.

Electrode Including Fuel Cell Catalyst

Still another aspect of the present disclosure is directed to an electrode including a catalyst manufactured by the method for manufacturing the fuel cell catalyst, or an electrode including the fuel cell catalyst.

Fuel Cell Including Fuel Cell Catalyst

Yet another aspect of the present disclosure is directed to a fuel cell including a catalyst manufactured by the method for manufacturing the fuel cell catalyst, or a fuel cell including the fuel cell catalyst. The fuel cell may include a membrane electrode assembly.

In one embodiment, the fuel cell includes a membrane electrode assembly including: a cathode; an anode positioned opposite to the cathode; and an electrolyte membrane interposed between the cathode and the anode, wherein one or more of the cathode and the anode may include the fuel cell catalyst according to the present disclosure. For example, the anode may include the fuel cell catalyst. In one embodiment, the fuel cell may further include a gas diffusion layer formed on one surface of each of the cathode and the anode.

The gas diffusion layer may be formed of a carbon sheet or carbon paper. The gas diffusion layer may diffuse oxygen and fuel, introduced into the membrane electrode assembly, toward the catalyst.

In one embodiment, the fuel cell may be a proton exchange membrane fuel cell, aka a polymer electrolyte membrane fuel cell (PEMFC), a phosphoric acid fuel cell (PAFC), or a direct methanol fuel cell (DMFC).

Hereinafter, the configuration and effects of the present disclosure will be described in more detail with reference to preferred examples. However, these examples are presented as preferred examples of the present disclosure and may not be construed as limiting the scope of the present disclosure in any way. The contents that are not described herein can be sufficiently and technically envisioned by those skilled in the art, and thus the description thereof will be omitted herein.

### EXAMPLES AND COMPARATIVE EXAMPLES

### Example 1

(1) Preparation of first mixture: A mixed solvent including 50 vol % of water and 50 vol % of ethylene glycol was prepared. 100 parts by weight of titanium suboxide (Ti₄O₇; CAS No. 107372-98-5;

manufactured by Alfa Chemistry) having an average size of 3.7 μm, 3.1 parts by weight of carbon (C-NERGYTRM Super C65; manufactured by TIMCAL Ltd.) having an average size of 32 nm, and 1000 parts by weight of the mixed solvent were dispersed ultrasonically, thereby preparing a first mixture.

(2) Preparation of second mixture: An iridium (Ir) precursor, a ruthenium (Ru) precursor, and a yttrium (Y) precursor were added at a molar ratio of 1:4:0.5 to the first mixture, thereby preparing a second mixture. The second mixture included the sum of the iridium precursor, the ruthenium precursor and the yttrium precursor and the sum of the titanium suboxide and the carbon at a weight ratio of 1:4, and the pH of the second mixture was 1 to 6.

(3) Preparation of intermediate: The second mixture was irradiated with an electron beam at 200 keV for 15 minutes, filtered and then washed with 3 L of distilled water, thereby preparing an intermediate.

(4) Heat treatment: The intermediate was heat-treated at 300° C., thereby manufacturing a fuel cell catalyst. The manufactured catalyst included a support including titanium suboxide and carbon, an active material (IrRu₄Y_{0.5}) supported on the support, at a weight ratio of 4:1.

### Example 2

A fuel cell catalyst was manufactured in the same manner as Example 1, except that 100 parts by weight of titanium suboxide and 5.3 parts by weight of carbon were used in the preparation of the first mixture.

### Example 3

A fuel cell catalyst was manufactured in the same manner as Example 1, except that 100 parts by weight of titanium suboxide and 7.5 parts by weight of carbon were used in the preparation of the first mixture.

### Example 4

A fuel cell catalyst was manufactured in the same manner as Example 1, except that 100 parts by weight of titanium suboxide and 9.9 parts by weight of carbon were used in the preparation of the first mixture.

### Comparative Example 1

As a fuel cell catalyst, a conventional Pt/C catalyst (including 19.7 wt % of Pt) (TKK Co., Ltd., TEC10EA20E) was used.

### Comparative Example 2

A fuel cell catalyst was manufactured in the same manner as Example 1, except that no carbon was used in the preparation of the first mixture.

### Comparative Example 3

A fuel cell catalyst including Ti₄O₇ and Pt at a weight ratio of 4:1 was manufactured by a solution reduction method using titanium suboxide (Ti₄O₇) as a support and platinum (Pt) as an active material. The solution reduction method was performed under a basic condition.

### Test Example

The performances of the fuel cell catalysts of Examples 1 to 4 and Comparative Examples 1 to 3 were evaluated in the following manner.

(1) Evaluation of hydrogen oxidation reaction (HOR): Using the catalysts of Examples 1 to 4 and Comparative Examples 1 to 3, rotating disk electrodes (RDEs) were prepared. Specifically, each of the catalysts was mixed with Nafion perfluorinated ion-exchange resin (Aldrich) and homogenized to prepare catalyst slurries which were then applied to glassy carbon electrodes, thereby manufacturing thin film-type electrodes.

Evaluation of the hydrogen oxidation reaction was performed using a 3-electrode system. Using a 0.1M perchloric acid (HClO₄) aqueous solution, saturated with hydrogen, as an electrolyte, a Pt foil as a counter electrode, and an Ag/AgCI electrode as a reference electrode, a constant voltage (0.08 V vs. RHE) was applied across electrodes, and in this state, the current depending on the rotating speed of each electrode was measured, and the hydrogen oxidation kinetic current was calculated by the Koutecky-Levich equation. The hydrogen oxidation kinetic current (HOR) activities of the catalysts of Examples 1 to 4 and Comparative Examples 2 and 3 were evaluated relative to the catalyst of Comparative Example 1, and the results of the evaluation are shown in Table 1 below.

TABLE 1

| | Hydrogen oxidation (HOR) kinetic |
|---|---|
| Examples | current activity (%) |
| Example 1 | 90.97 |
| Example 2 | 91.75 |
| Example 3 | 90.97 |
| Example 4 | 91.58 |
| Comparative Example 1 | 100 |
| Comparative Example 2 | 87.33 |
| Comparative Example 3 | 99.78 |

Referring to the results in Table 1 above, it could be seen that the catalysts of Examples 1 to 4 of the present disclosure had better hydrogen oxidation reaction performance than Comparative Example 2, and had lower hydrogen oxidation kinetic current activities than Comparative Examples 1 and 3.

(2) Evaluation of oxygen evolution reaction: Using the catalysts of Examples 1 to 4 and Comparative Example 1 representative of the Examples and the Comparative Examples, rotating disk electrodes (RDEs) were prepared in the same manner as the above Test Example.

Evaluation of the oxygen evolution reaction was performed using a 3-electrode system. Using a 0.1M perchloric acid (HClO₄) aqueous solution, saturated with nitrogen, as an electrolyte, a Pt foil as a counter electrode, and an Ag/AgCI electrode as a reference electrode, the oxygen evolution reaction activity of each catalyst was evaluated by linear sweep voltammetry (LSV), and the results of the evaluation are shown in FIG. 3.

Referring to the results in FIG. 3, it could be seen that the oxygen evolution reaction activities of Examples 1 to 4 were better than that of Comparative Example 2. In addition, the oxygen evolution reaction activities of Comparative Examples 1 and 3 were too low to measure.

Simple modifications or variations of the present disclosure may be easily carried out by those skilled in the art, and all such modifications or variations can be considered included in the scope of the present disclosure.

What is claimed is:

1. A fuel cell catalyst comprising: a support comprising titanium suboxide and carbon; and an active material supported on the support and comprising iridium (Ir), ruthenium (Ru), and yttrium (Y).

2. The fuel cell catalyst of claim 1, wherein the active material is represented by the following Formula 1:
IrRuₐY_{b} [Formula 1]
wherein a is between 1 and 5 (1≤a≤5), and b is between 0.1 and 2 (0.1≤b≤2).

3. The fuel cell catalyst of claim 1, wherein the support comprises 100 parts by weight of the titanium suboxide and about 1 to 20 parts by weight of the carbon.

4. The fuel cell catalyst of claim 1, wherein the active material and the support are comprised at a weight ratio of about 1:0.5 to 1:20.

5. The fuel cell catalyst of claim 1, wherein the carbon comprises one or more of carbon black, carbon nanotubes (CNTs), graphite, graphene, activated carbon, mesoporous carbon, carbon fibers, and carbon nanowires.

6. A method for manufacturing a fuel cell catalyst, the method comprising:
preparing a first mixture including titanium suboxide, carbon, and a solvent;
preparing a second mixture by adding an iridium (Ir) precursor, a ruthenium (Ru) precursor, and a yttrium (Y) precursor to the first mixture; and
preparing an intermediate using the second mixture.

7. The method of claim 6, wherein the first mixture is prepared by adding the titanium suboxide and the carbon to the solvent, followed by ultrasonic dispersion.

8. The method of claim 6, wherein the solvent comprises one or more of water, isopropyl alcohol, methanol, ethanol, ethylene glycol, and propylene glycol.

9. The method of claim 8, wherein the solvent comprises about 10 to 50 vol % of water and about 50 to 90 vol % of ethylene glycol.

10. The method of claim 6, wherein the iridium (Ir) precursor, the ruthenium (Ru) precursor, and the yttrium (Y) precursor are added at a molar ratio of about 1:1 to 5:0.1 to 2.

11. The method of claim 6, wherein the second mixture has a pH of about 1 to 6.

12. The method of claim 6, wherein the intermediate is prepared by irradiating the second mixture with an electron beam.

13. The method of claim 12, wherein the irradiating with the electron beam is performed by irradiating the second mixture with an electron beam at about 100 to 500 keV.

14. The method of claim 12, further comprising heat-treating the prepared intermediate at a temperature of about 200 to 400° C.

15. The method of claim 6, wherein the intermediate is prepared by heat-treating the second mixture at a temperature of about 150 to 280° C.

16. A fuel cell electrode comprising the fuel cell catalyst of claim 1.

17. A fuel cell comprising the fuel cell catalyst of claim 1.
